(19) United States
(12) Patent Application Publication
(10) Pub. No.: US 2018/0267604 A1
(43) Pub. Date: Sep. 20, 2018

(54) COMPUTER POINTER DEVICE

(71) Applicant: Neil Bhattacharya, Woodridge, IL (US)

(72) Inventor: Neil Bhattacharya, Woodridge, IL (US)

(21) Appl. No.: 15/463,315

(22) Filed: Mar. 20, 2017

(51) Int. Cl. G06F 3/01; G06F 3/0346; G06F 3/03; G06T 7/70; G06T 7/00

(52) U.S. Cl. CPC G06F 3/013; G06F 3/012; G06F 3/0346; G06T 2207/30201; G06T 7/70; G06T 7/97; G06F 3/0304

(57) ABSTRACT

A pointing device is provided. The pointing device is controlled by eye-tracking and head-tracking, wherein the device is worn on the user's head so as to incorporate the user's eye and head movements to control the pointer. So that once calibrated, where a user looks on the user interface is exactly where the cursor goes, freeing up both hands to use the keyboard.

### BACKGROUND OF THE INVENTION

The present invention relates to computer input devices and, more particularly, to a pointing device controlled by eye-tracking and head-tracking.

The world's most prevalent style of computer-user interface employs a mouse as a pointing device to control the position of the pointer, or cursor. Using a mouse to control a cursor, however, takes one hand away from the keyboard. Mouse clicks can also be time consuming and at times inaccurate.

While some eye-tracking systems use eye movements like a joystick to control the cursor, they do not incorporate head-tracking.

As can be seen, there is a need for a pointing device controlled by eye-tracking and head-tracking, wherein the device is worn on the user's head so as to incorporate the user's eye and head movements to control the pointer. So that once calibrated, where a user looks on the user interface is exactly where the cursor goes, freeing up both hands to use the keyboard, and making clicks more accurate and intuitive.

### SUMMARY OF THE INVENTION

In one aspect of the present invention, a system for controlling a pointer of a user interface includes an eye frame adapted to be worn by a human user; an optical sensor attached to the eye frame, wherein the optical sensor is adapted to sense eye movement of an adjacent eye of said human user; an emitter attached along a periphery of the user interface; a motion sensor attached to the eye frame, wherein the motion sensor is adapted to sense movement of the eyewear relative to the emitter; and a microprocessor electrically connected to the optical sensor, the motion sensor, and the pointer, wherein the microprocessor is configured to position the pointer based in part on said eye and head movement.

In another aspect of the present invention, a pointing device for controlling a pointer of a user interface includes an optical sensor adapted to attach to an eye frame so that the optical sensor is adapted to sense eye movement of a human user of the eye frame; a motion sensor attached to the eye frame, wherein the motion sensor is adapted to sense relative movement of the eyewear relative to an emitter attached along a periphery of the user interface; and a microprocessor electrically connected to the optical sensor, the motion sensor, and the pointer, wherein the microprocessor is configured to position the pointer based in part on said eye and head movement; at least one light source attached to the eye frame, wherein the at least one light source is adapted to illuminate a pupil and a specular highlight of the adjacent eye; and an accelerometer attached to the eye wear and electrically connected to the microprocessor, wherein the accelerometer is adapted to sense movement of the eye wear.

In another aspect of the present invention, a computer-implemented method for controlling a pointer of a user interface includes providing an eye frame adapted to be worn by a human user; attaching an optical sensor to the eye frame, wherein the optical sensor is adapted to sense eye movement of an adjacent eye of said human user; attaching an emitter along a periphery of the user interface; attaching a motion sensor to the eye frame, wherein the motion sensor is adapted to sense movement of the eyewear relative to the emitter; electrically connecting a microprocessor to the optical sensor, the motion sensor, and the pointer, wherein the microprocessor is configured to position the pointer based in part on said eye and head movement; attaching at least one light source to the eye frame, wherein the at least one light source is adapted to illuminate a pupil and a specular highlight of the adjacent eye; calibrating four eye-direction vectors and four head-direction vectors by capturing eye images of the pupil and the specular highlight and emitter images, respectively, while the human users successively looks at the corners of the user interface during a calibration phase; and comparing subsequent eye images and emitter images to the eye direction vectors and the head-direction vectors, respectively, so as to position the pointer based on the relative differences in position between the subsequent eye and emitter images and the eye and head-direction vectors, respectively.

These and other features, aspects and advantages of the present invention will become better understood with reference to the following drawings, description and claims.

### BRIEF DESCRIPTION OF THE DRAWINGS

FIG. 1 is a schematic diagram of an exemplary embodiment of the present invention;

FIG. 2 is a front perspective view of an exemplary embodiment of the present invention;

FIG. 3 is a left elevation view of an exemplary embodiment of the present invention;

FIG. 4 is a top plan view of an exemplary embodiment of the present invention;

FIG. 5 is a front elevation view of an exemplary embodiment of the present invention;

FIG. 6 is a right elevation view of an exemplary embodiment of the present invention;

FIG. 7 is a left elevation view of an exemplary embodiment of the present invention; and

FIG. 8 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a pointing device. The pointing device is controlled by eye-tracking and head-tracking, wherein the device is worn on the user's head so as to incorporate the user's eye and head movements to control the pointer. So that once calibrated, where a user looks on the user interface is exactly where the cursor goes, freeing up both hands to use the keyboard.

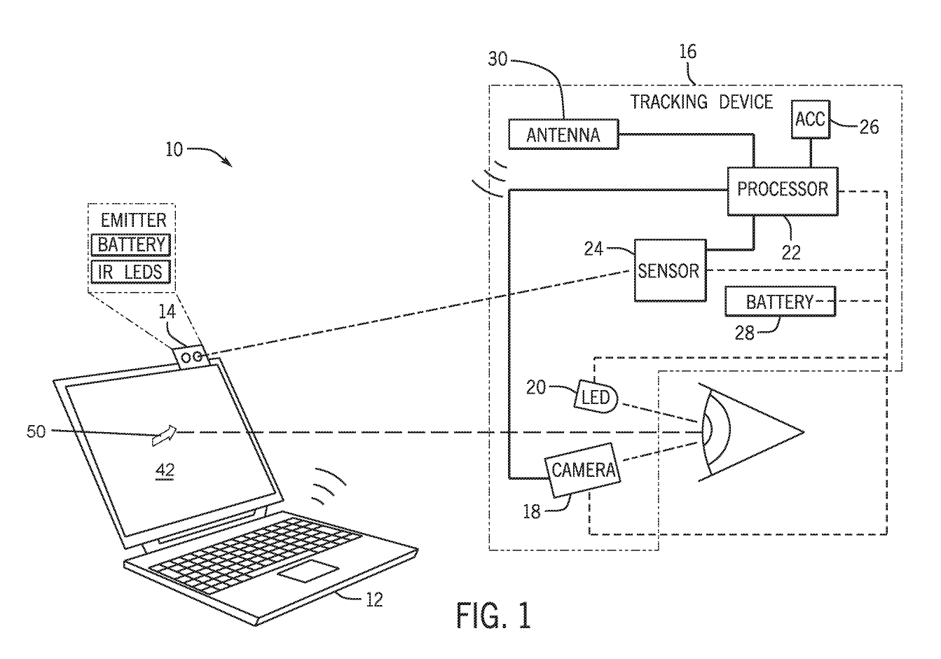

Referring to FIG. 1, the present invention may include at least one computer with a user interface 42, wherein the user interface 42 may include a touchscreen or other input device and output device layered on the top of an electronic visual display of an information processing system. The computer may include at least one processing unit coupled to a form of memory including, but not limited to non-user-interface computing devices, such as a server and a microprocessor 22, and user-interface computing devices, such as a desktop, a laptop 12, and smart device, such as a tablet, a smart phone, smart watch, or the like. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud, wifi network, and the like.

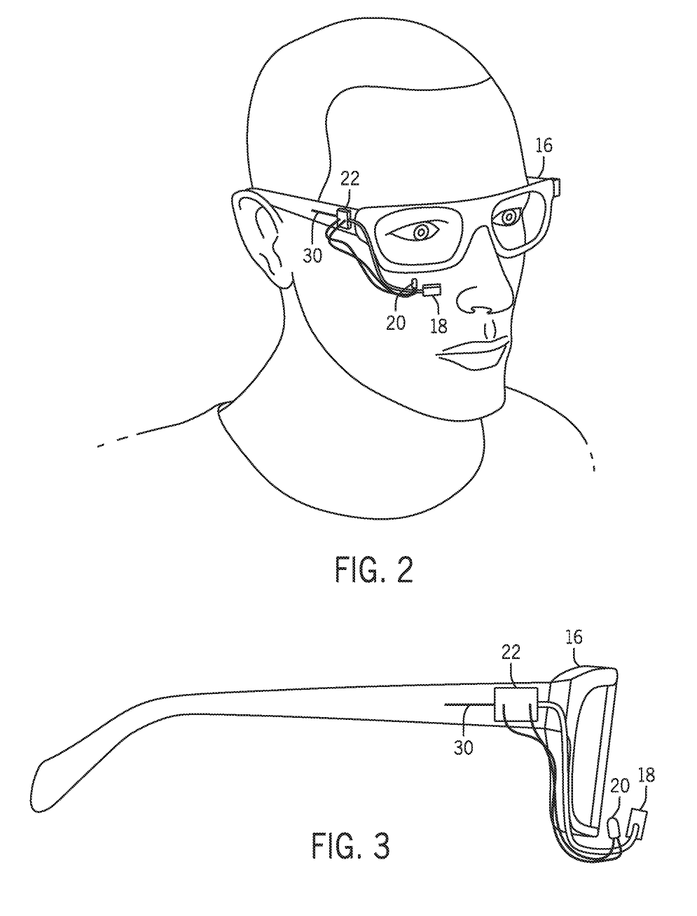

Referring to FIG. 2, the present invention may include a pointer device 10 adapted to be removably attached to or be integrated with an eye frame 16. The eye frame 16 may be dimensioned and adapted to be worn by a human as standard eyeglasses would be.

The pointer device 10 may include the arrangement of electrical connected components: an optical sensor 18, at least one light source 20, a microprocessor 22, a motion sensor 24, an accelerometer 26, a power supply 28, an antenna 30, and/or a cable 32. The electrical connected components may be connected by the cable 32, wirelessly via the antenna 30, or both.

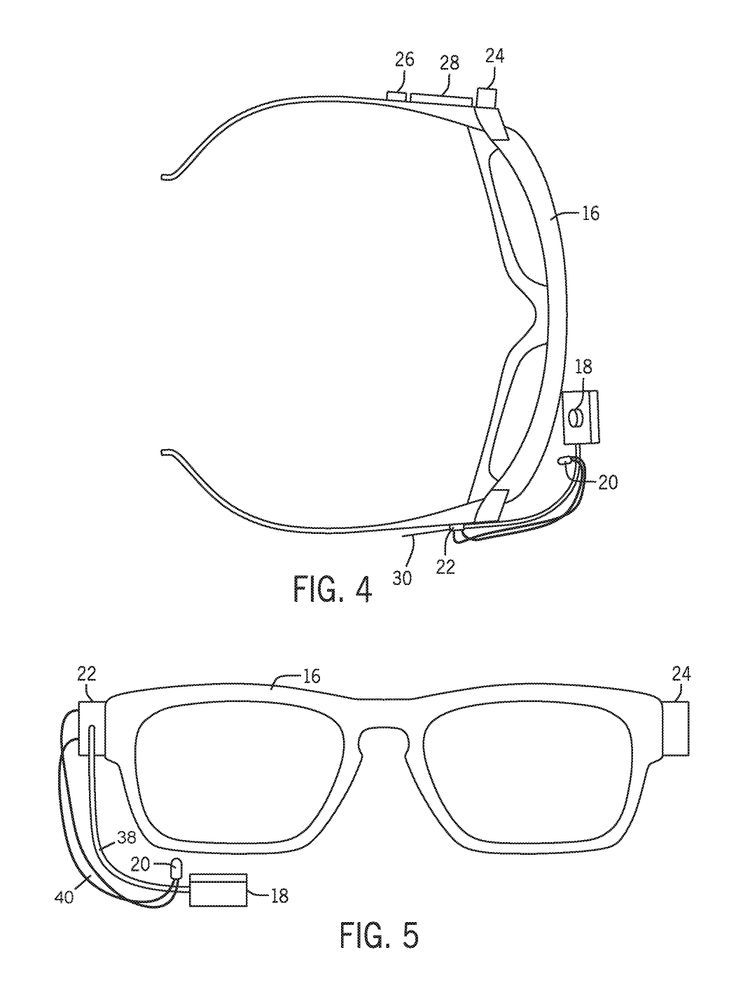

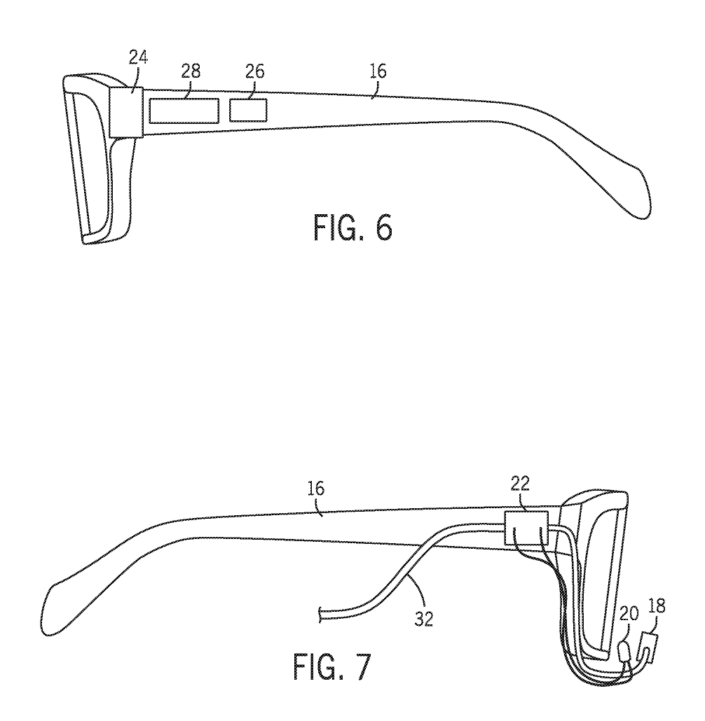

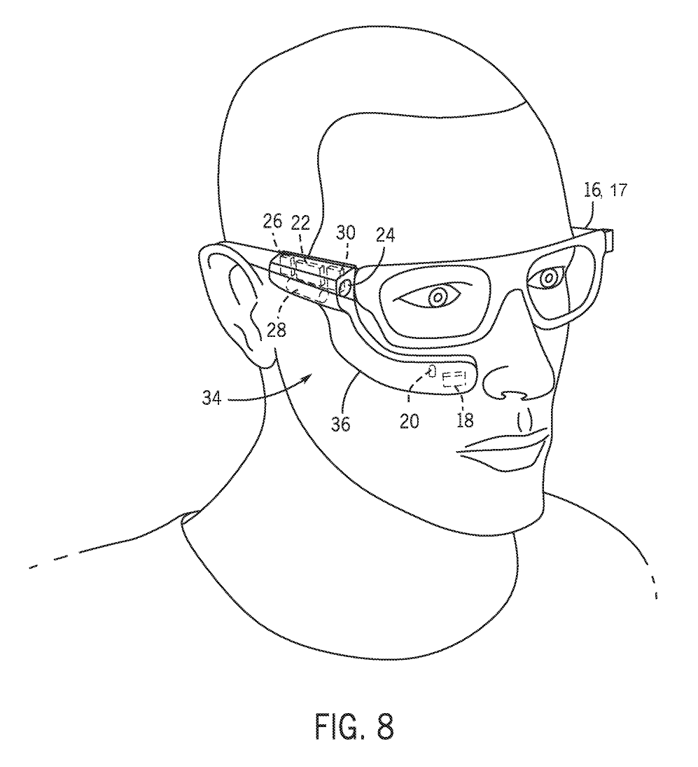

The electrical connected components may be mounted and/or integrated along various portions of the eye frame 16, as illustrated in FIGS. 2-7. Alternatively, the electrical connected components may be independently housed in a housing 36 that is removably connectable to either the eye frame 16 or a user's current eyewear 17 as an independent pointer device 34, as illustrated in FIG. 8. In either case, the power supply 28 powers the electrical components.

The optical sensor 18 may be a device for recording or capturing images, specifically to collect eye movement data. The optical sensor 18 may have infrared capability. The optical sensor 18 may be disposed adjacent an eye of the human wearer of the eye frame 16. Generally, the optical sensor 18 will be outside the field of view of said human wearer, such as beneath the eye, adjacent to a lower portion of the eye frame 16, though oriented to collect said eye's movement data. In some embodiments, the optical sensor 18 may be mounted on a protrusion along the lower rim of the eye frame 16 in front of the eye. In certain embodiments, a first adjustable arm 38 may interconnect the eye frame 16 and the optical sensor 18.

The at least one light source 20 may have infrared capability. The at least one light source 20 may include LEDs positioned to illuminate the eye sufficiently for the optical sensor 18 to capture images thereof. In some embodiments, the at least one light source 20 may be mounted on a protrusion along the lower rim of the eye frame 16 in front of the eye as well. In certain embodiments, a second adjustable arm 40 may interconnect the eye frame 16 and the at least one light source 20. In either embodiment, the at least one light source 20 and the optical sensor 18 are spaced at least 3 centimeters apart.

In certain embodiments, the optical sensor 18 and the least one light source 20 may independently track each eye. Tracking each eye independently can be useful in determining the conversion of the eyes and therefore a user's perception of 3D. By adding polarized 3D lenses a more immersive 3D experience can be achieved.

The motion sensor 24 may be disposed along the eye frame 16. The motion sensor 24 may be may be adapted to collect head movement data. An emitter 14 may be provided along the user interface 42, or just outward thereof, providing the pointer 50 to be controlled. The emitter may include infrared capability, such as infrared LEDs, and be adapted to monitor, calibrate and enable the motion sensor 24. The motion sensor 24 may be oriented to face the emitter 14, or otherwise front facing relative to the eye frame 16. In certain embodiments, the motion sensor 24 may be mounted on the eye frame 16 near a hinge thereof. In certain embodiments, the accelerometer 26 is provided to compliment the motion sensor 24 in gathering head movement data.

The microprocessor 22 may be adapted to receive and process the eye and head movement data collected by the optical sensor 18 and move the pointer 50 accordingly.

The optical sensor 18 in conjunction with the at least one light source 20 captures a plurality of eye images of the adjacent eye, which includes the pupil and specular highlight caused by the at least one light source 20, which again may be infrared LEDs. These eye images are relayed to the microprocessor 22. At the same time the motion sensor 24 is adapted to capture emitter images of the emitter 14 adjacent the user interface 42 and relays these images to the microprocessor 22.

### Vector Calibration Phase

The microprocessor 22 may be configured to compare the pupil and specular highlight images captured by the real-time eye images to deduce an eye-direction vector. Likewise, the microprocessor 22 may be configured to use the real-time emitter images from the motion sensor 24 to deduce a head-direction vector. The microprocessor 22 takes the dot-product of these two vectors to calculate a vector that represents the direction the person is looking, eye and head movement data combined. During the calibration phase four eye-direction vectors are stored, one for each corner of the screen. The images taken during the calibration phase are used to store four head-direction vectors as well. In certain embodiments, the accelerometer 26 can be used to aid the motion sensor 24 in obtaining the head-direction vector. In less than optimal lighting, different head positions that produce similar images by the motion sensor 24 can be differentiated by the accelerometer 26.

### Pointer Positioning Phase

In real-time, the microprocessor 22 processes the eye images and the emitter images. The microprocessor 22 may be adapted to identify the position of the pupil and specular highlights in the eye images so as to compare them to their positions obtained from the calibration step. Likewise, the real-time emitters images are also compared to the emitter images obtained through the calibration step, and the relative differences in position of the two sets of images are interpreted as the location the user is looking. The microprocessor 22 can then place the pointer 50 at the point the user is looking.

A method of using the present invention may include the following. The pointer device 10 disclosed above may be provided. A user would wear the eye frames 16 as they would eye glasses while computing. Alternatively, if already having eyewear 17, the user may removably attached the attachable pointer device 34. After powering on the pointer device and connecting it to the computer 12 via Bluetooth or the like, the user would be prompted to calibrate the pointer device 10 by looking at the corners of the screen/user interface 42 in succession. After calibration, the user would simply look at the screen/user interface 42 and the pointer 50 would move to where they are looking. The pointer 50 position along the user interface 42 is instantly updated in real-time according to the processing by the microprocessor 22 of the eye and emitter images, positioning the pointer 50.

The user can keep their hands on the keyboard or controller without needing to manipulate the pointer 50 with their hands.

Additionally, with the variant in which both eyes are independently tracked, and polarized 3D lenses are added to the eye frame 16, the user can use the device just like 3D goggles, but is given a 3D experience that includes conversion, resulting in a more immersive 3D experience.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for controlling a pointer of a user interface, comprising:
an eye frame adapted to be worn by a human user;
an optical sensor attached to the eye frame, wherein the optical sensor is adapted to sense eye movement of an adjacent eye of said human user;
an emitter attached along a periphery of the user interface;
a motion sensor attached to the eye frame, wherein the motion sensor is adapted to sense movement of the eyewear relative to the emitter; and
a microprocessor electrically connected to the optical sensor, the motion sensor, and the pointer, wherein the microprocessor is configured to position the pointer based in part on said eye and head movement.

2. The system of claim 1, further comprising at least one light source attached to the eye frame, wherein the at least one light source is adapted to illuminate a pupil and a specular highlight of the adjacent eye.

3. The system of claim 1, further comprising an accelerometer attached to the eye wear and electrically connected to the microprocessor, wherein the accelerometer is adapted to sense movement of the eye wear.

4. A pointing device for controlling a pointer of a user interface, comprising:
an optical sensor adapted to attach to an eye frame so that the optical sensor is adapted to sense eye movement of a human user of the eye frame;
a motion sensor attached to the eye frame, wherein the motion sensor is adapted to sense relative movement of the eyewear relative to an emitter attached along a periphery of the user interface; and
a microprocessor electrically connected to the optical sensor, the motion sensor, and the pointer, wherein the microprocessor is configured to position the pointer based in part on said eye and head movement.

5. The device of claim 4, further comprising at least one light source attached to the eye frame, wherein the at least one light source is adapted to illuminate a pupil and a specular highlight of the adjacent eye.

6. The system of claim 5, further comprising an accelerometer attached to the eye wear and electrically connected to the microprocessor, wherein the accelerometer is adapted to sense movement of the eye wear.

7. A computer-implemented method for controlling a pointer of a user interface, comprising:
providing an eye frame adapted to be worn by a human user;
attaching an optical sensor to the eye frame, wherein the optical sensor is adapted to sense eye movement of an adjacent eye of said human user;
attaching an emitter along a periphery of the user interface;
attaching a motion sensor to the eye frame, wherein the motion sensor is adapted to sense movement of the eyewear relative to the emitter;
electrically connecting a microprocessor to the optical sensor, the motion sensor, and the pointer, wherein the microprocessor is configured to position the pointer based in part on said eye and head movement;
attaching at least one light source to the eye frame, wherein the at least one light source is adapted to illuminate a pupil and a specular highlight of the adjacent eye;
calibrating four eye-direction vectors and four head-direction vectors by capturing eye images of the pupil and the specular highlight and emitter images, respectively, while the human users successively looks at the corners of the user interface during a calibration phase; and
comparing subsequent eye images and emitter images and their resulting eye direction vector and head direction vector to the calibration eye direction vectors and head-direction vectors, respectively, so as to position the pointer based on the relative differences in position between the subsequent eye and emitter images and the calibration eye and head-direction vectors, respectively.
